(19) United States
(12) Patent Application Publication
(10) Pub. No.: US 2026/0258911 A1
(43) Pub. Date: Sep. 3, 2026

(54) CRYOSTAT FOR A SPACE COMPONENT

(71) Applicant: AIRBUS DEFENCE AND SPACE SAS, Toulouse Cedex 4 (FR)

(72) Inventors: Delphine CARPONCIN, Toulouse Cedex 4 (FR); Coraline SIMON, Toulouse Cedex 4 (FR); Eric DE STEFANI, Toulouse Cedex 4 (FR)

(21) Appl. No.: 18/715,453

(22) PCT Filed: Nov. 29, 2022
(86) PCT No.: PCT/FR2022/052191

§ 371 Date: Aug. 27, 2024

(30) Foreign Application Priority Data
Dec. 2, 2021 (FR) FR2112876

(51) Int. Cl. F17C 13/00; B64G 1/66; G01J 1/02

(52) U.S. Cl. CPC F17C 13/006; B64G 1/66; G01J 1/0252; F17C 2201/0109; F17C 2201/035; F17C 2203/0308; F17C 2203/0636; F17C 2205/018; F17C 2270/0194

(57) ABSTRACT

A cryostat intended to receive a space component operating at cryogenic temperature is disclosed including a central, closed, cooled enclosure configured to receive the space component; successive metal shields, including an internal shield, an external shield and one or more intermediate shield(s) arranged around one another so that each delimits a closed volume receiving the preceding shield of smaller size; a cooling device for cooling the central enclosure to cryogenic temperature; internal inter-shield joining elements which keep the shields spaced apart from one another. The cryostat includes at least one integral portion includes a series of partitions including an internal partition, an external partition and one or more intermediate partition(s), respectively corresponding to a portion of the internal shield, a portion of the external shield and a portion of the intermediate shield(s).

### CROSS REFERENCE TO RELATED APPLICATIONS

The present application is a National Phase of International Application Number PCT/FR2022/052191 filed Nov. 29, 2022, which designated the U.S. and claims priority benefits from French Application Number FR 2112876 filed Dec. 2, 2021, the entire contents of each of which are hereby incorporated by reference.

### TECHNICAL FIELD

The present invention relates to the field of space industry, in particular to devices for the thermal control of artificial satellites, space probes and the like.

More particularly, the invention relates to a cryostat, intended to receive a component, such as for example an optical component, operating at very low temperature. The cryostat is intended to be carried, with the component, in a spacecraft such as a satellite, for example a scientific satellite for observation of the Earth.

### PRIOR ART

Some space components, such as infrared optical detectors, should be implemented at very low stabilized temperatures, so-called cryogenic temperatures, so that their performances are guaranteed. For infrared (IR) imaging, a cryostat allows for example a decoupling of the temperatures between the satellite platform on which the cryostat is fastened and the inside of the cryostat in which the optical component is enclosed, comprising IR sensors intended to operate at cryogenic temperatures (in the range of 60 K).

FR2410211 discloses a liquid cryogen (helium) cryostat intended to cooperate with an optical system, for example in the context of astrophysical and infrared spectroscopy experiments. The cryostat comprises a tank containing liquid helium, suspended inside a sealed enclosure in which vacuum has been created. The tank is provided with a neck on which heat exchangers are mounted intended to recover the enthalpy of the cryogenic gas and on which radiation panels cooled by the exchangers are also mounted and intended to limit the energy transmitted to the helium bath following the external radiation and the thermal conduction in the neck of the tank and in its suspension members.

This cryostat type has a particularly complex architecture, composed of a large number of assembled parts thereby resulting in long and expensive integration processes, and the assembly of which is even more critical since the space domain requires complying with very demanding geometric, mechanical and thermal specifications. Furthermore, this architecture type generally limits the size and the shape of the devices that it could accommodate in a useful space with a limited volume. U.S. Pat. No. 3,253,423 discloses another cryostat which is complex to manufacture.

### DISCLOSURE OF THE INVENTION

The invention aims to overcome at least one of the aforementioned drawbacks. In particular, an objective of the invention is to provide a cryostat with a simple architecture, easy to manufacture at a controlled cost, and capable of housing components of various shapes and sizes, while having reduced size and mass. Another objective of the invention is to provide a cryostat capable of withstanding temperature variations between its external and internal environment as well as considerable accelerations and mechanical forces, without this affecting its performances.

For this purpose, the invention provides a cryostat intended to receive at least one space component operating at cryogenic temperature, the cryostat comprising:
a central, closed and cooled enclosure, configured to receive the space component,
successive metal shields, spaced apart from one another, including an internal shield, an external shield and one or more intermediate shield(s), the internal shield supporting the space component and delimiting the central enclosure receiving said space component, the intermediate shield(s) and the external shield being arranged around one another so that each delimits a closed volume receiving the preceding shield of smaller size,
a cooling device for cooling the central enclosure at cryogenic temperature,
external securing elements fastened to the external shield, for securing the cryostat to a satellite platform,
internal inter-shield joining elements, which hold said shields spaced apart from one another.

The cryostat according to the invention is characterized in that it comprises at least one integral portion comprising a series of partitions including an internal partition, an external partition and one or more intermediate partition(s), respectively corresponding to a portion of the internal shield, a portion of the external shield and a portion of the one or more intermediate shield(s), said partitions being spaced apart from one another and held together by at least one portion of the internal inter-shield joining elements.

According to a possible feature, the cooling device comprises one or more cold finger(s) for cooling the central enclosure and, for each of the cold fingers, a transverse passage passing through the successive metal shields up to the central enclosure for receiving said cold finger, the cold finger(s) not being in contact with the shields.

According to a possible feature, the internal inter-shield joining elements are arranged between the successive shields and configured to confer mechanical strength thereon on their own between the external shield and the internal shield, said internal joining elements being configured to withstand determined forces induced at least by a mass of the space component and masses of the shields.

According to a possible feature, the internal inter-shield joining elements comprise V-shaped double rods between the successive shields, the Vs being angularly distributed around a main axis (X) or a central point of the cryostat according to at least three radial directions.

According to a possible feature, the internal inter-shield joining elements comprise several sets of single rods, the single rods of a same set being aligned according to a straight line passing through the shields, the straight lines of two distinct sets being non-parallel and non-coplanar with one another.

According to a possible feature, the internal inter-shield joining elements are made in one-piece with at least part of the shields.

According to a possible feature, the integral portion of the cryostat is made by additive manufacturing.

According to a possible feature:
the cryostat comprises a plurality of integral portions as defined before, i.e. each having an internal partition, an external partition and one or more intermediate partition(s), the partitions of two distinct integral portions among said integral portions corresponding to two distinct portions of the shields,
the intermediate or internal partitions, two distinct and adjacent integral portions among the plurality of integral portions, which are in line with one another being non-contiguous,
the external partitions, of two distinct and adjacent integral portions among the plurality of integral portions, which are in line with one another being contiguous and fastened to one another.

In other words, two integral portions that are adjacent are fastened to one another by their external partitions and only by these.

According to a possible feature, the intermediate or internal partitions which are in line with one another, have facing ends at least one of these facing ends has a recess so as to form a baffle with the other facing end.

According to a possible feature, the external securing elements are either all fastened on the external partition of only one of the integral portions, or distributed over the external partitions of several ones of the integral portions.

According to a possible feature, at least one of said integral portions is an annular structural portion wherein each internal, intermediate and external partition is annular.

According to a possible feature, each of the shields of the cryostat is entirely formed by the assembly of the partitions of the integral portions.

Alternatively, the cryostat comprises at least one integral annular structural portion as defined before and:
the cryostat comprises at least one series of independent cowls including, for each series, an internal cowl, an external cowl and one or more intermediate cowl(s), each series of cowls respectively corresponding to another portion of the shields, the cowls of the same series being arranged inside one another, at a distance from one another, with no internal joining elements; in other words, unlike the partitions of the annular structural portion (or more generally of the aforementioned integral portions), the cowls are not directly connected to one another;
each of said cowls lying in line with and being fastened to one of the partitions of said annular structural portion, each of the shields of the cryostat thereby being entirely formed by at least one of the partitions of the annular structural portion and by one of the cowls of each series.

It should be noted that, in this variant, the cryostat may comprise several integral portions corresponding to different portions of the shields, the shields being integrally formed thanks to the attachment (to the partitions of said integral portions) of one or more serie(s) of independent cowls, respectively corresponding to one or more other portion(s) of the shields.

According to a possible feature, at least one portion of each of the cowls is provided with a golden coating.

According to a possible feature, each of the cold fingers defined hereinabove is thermally insulated from the shields, a heat-insulating coating being arranged against at least one of the cold fingers in the transverse passage of said cold finger, and/or a bellow-fashioned heat-insulating coating being arranged around at least one of the cold fingers, in the transverse passage of said cold finger and between the shields.

The invention also covers a spacecraft, for example a satellite, characterized in that it comprises a space component, which operates at cryogenic temperature and is arranged in a cryostat according to the invention, the cryostat being fastened on a platform of the spacecraft.

The fundamental concepts of the invention having just been described hereinabove in their most elementary form, other details, features and advantages will become apparent upon reading the following description and with reference to the appended drawings, given as non-limiting embodiments of a cryostat in accordance with the principles of the invention.

### BRIEF DESCRIPTION OF THE FIGURES

FIG. 1 is a schematic perspective view of a first example of a cryostat according to the invention, comprising two integral portions.

FIG. 2 shows the cryostat of FIG. 1 viewed in section according to a longitudinal midplane.

FIG. 3 is a front view of an integral portion of the cryostat of FIG. 1.

FIG. 4 is a perspective view of the integral portion of FIG. 3, on the closed side.

FIG. 5 is another perspective view of the integral portion of FIG. 3, on the open side.

FIG. 6 is a perspective view, on the closed side, of the other integral portion of the cryostat of FIG. 1.

FIG. 7 is another perspective view of the integral portion of FIG. 6, on the open side.

FIG. 8 shows the shields of the cryostat of FIG. 1, viewed in section by a transverse plane, showing V-shaped internal joining elements.

FIG. 9A is a partial section according to a longitudinal plane A-A of the shields of FIG. 8.

FIG. 9B is a partial section according to a longitudinal plane B-B of the shields of FIG. 8.

FIG. 10 is a schematic sectional view of the cryostat of the previous figures with its two integral portions assembled, showing the configuration of the internal joining elements.

FIG. 11 is a perspective view of the integral portion of FIG. 3 and of a space component operating at cryogenic temperature, shown separately and intended to be accommodated therein.

FIG. 12 is a front view of the integral portion of FIG. 3 containing the space component with functional members of the cryostat, such as cold fingers, shown separately.

FIG. 12A shows a cold finger passing through the shields according to one embodiment.

FIG. 12B shows a cold finger passing through the shields according to another embodiment.

FIG. 13 shows the elements of FIG. 12 when assembled, viewed from the front.

FIG. 14 is a perspective view of the cryostat of FIG. 12 when completely assembled.

FIG. 15 is an exploded perspective view of a second example of a cryostat according to the invention, comprising three integral portions, namely an annular central portion, a base and a cowl.

FIG. 16 is a perspective view of the annular central portion and of the base of the cryostat of FIG. 15, with one or more detector(s) and their equipment (the space component) fastened to the base.

FIG. 17 is a perspective view of the cryostat of FIG. 15 containing the space component operating at cryogenic temperature, before closure thereof by the cowl.

FIG. 18 is a top view of the cryostat of FIG. 17 without the cowl.

FIG. 18b is shows a detail of the arrangement of the ends of partitions forming shields, for example relating to the second example of a cryostat of FIGS. 15 to 18.

FIG. 19 is an exploded perspective view of a third example of a cryostat according to the invention, comprising an annular integral portion and two series of cowls.

FIG. 20 is a sectional view by a longitudinal midplane of the cryostat of FIG. 19 equipped with various functional members and containing a space component operating at cryogenic temperature.

FIG. 21 shows a detail of FIG. 20, in perspective.

FIG. 22 shows a satellite according to the invention.

The different figures and the elements of the same figure are not necessarily plotted at the same scale. Moreover, all these figures are schematic, with various degrees of details. Finally, it should be noted that, in all figures, identical or equivalent elements bear the same reference numeral.

### DETAILED DESCRIPTION

In the present description, reference is made to a cryostat primarily intended for an optical instrument, such as an infrared interferometer, on-board a meteorological-type satellite. This non-limiting example is given for a better understanding of the invention and does not exclude the use of the cryostat in other applications, for example to cooperate with other measurement instruments in observation, telecommunication or astrophysical study satellites.

Throughout the description, the term “satellite” refers to an artificial satellite, and the synonymous expressions “additive manufacturing” and “3D printing” are indifferently used to refer to any computer-aided process for shaping a part by stacking successive layers or by any material addition.

For example, the space component operating at cryogenic temperature is a sensitive component forming a detector such as an optical detector.

FIG. 1 shows a cryostat 100 according to a first embodiment formed from two integral portions 10a and 10b, joined together.

Each integral portion 10a, 10b comprises a series of partitions including an internal partition 13a(1), 13b(1), an external partition 13a(3), 13b(3) and intermediate partitions 13a(2), 13b(2).

External securing elements 20 allow fastening the cryostat to a satellite platform (not shown).

When they are assembled, the integral portions 10a and 10b form a series of closed metal shields 13, arranged around one another. Thus, the internal, intermediate and external partitions of the integral portions respectively form an internal shield, intermediate shields and an external shield.

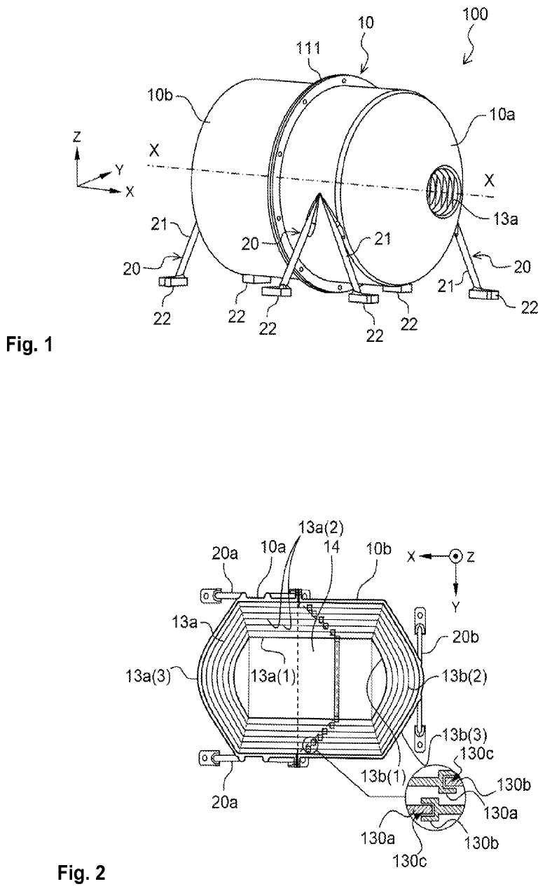

As shown in FIG. 2, the shield 13 of smaller size, located inside all the others, delimits a closed central enclosure 14 whose useful volume has a shape and dimensions adapted to the integration of one or more space component(s) operating at low or very low temperatures (in the range of 60 K for example).

For example, the internal metal shield which delimits the cryogenic enclosure is not sealed but forms a barrier to thermal radiations. For example, the intermediate metal shields are not sealed but each forms a barrier to thermal radiations.

In the illustrated example, the body 10 generally has a symmetry of revolution around a longitudinal axis X.

Each of the integral structural portions 10a and 10b has (cf. FIGS. 4 and 6) a cylindrical external partition 11a, 11b, open on one side according to a circular section and extended, on the other side by a conical portion 12a, 12b. The open circular side is provided with a circular fastening flange 111a and 111b. These flanges enable junction and fastening of the external partitions to one another, for example via suitable clamping means such as bolts inserted into facing holes.

Each internal partition 13a(1) or respectively intermediate partition 13a(2) of the integral portion 10a is arranged in line with an internal partition 13b(1) or respectively intermediate partition 13b(2) of the integral portion 10b. The facing ends 130a and 130b of two internal or intermediate partitions located in line with one another remain at a distance from one another. The approach areas of these facing ends are longitudinally offset (i.e. these approach areas between the internal or intermediate partitions are not located in the same transverse plane) to increase the thermal radiation barrier effect and to enable mounting thereof while keeping a reduced distance between successive shields.

Thus, providing for non-contiguous intermediate and internal partitions allows limiting the friction between the partitions and the erosion of the partitions which occurs at their junction under the effect of the vibrations experienced by the cryostat, such erosion should be avoided because it could produce particles likely to detach from the partitions, migrate towards the central enclosure of the cryostat and pollute the space component located therein.

Furthermore, one of the facing ends 130a is extended according to a U-shaped profile to create a baffle 130c with the other end 130b, and thus further increase the thermal radiation barrier effect. Alternatively, it would have been possible to extend either one or both of the facing ends according to an L-shaped profile.

The formation of such a baffle 130c upon passage through a shield allows limiting radiative heat exchanges between successive shields by forming barriers.

In order to keep the space component operating at cryogenic temperature at low or very low temperatures, the enclosure 14 is cooled by two cold fingers 60 each arranged in a transverse passage 15 passing through the successive metal shields from the external shield up to the internal shield to arrive at the central chamber 14.

It is also possible to consider a cryostat operating using one single cold finger.

Thus, the body 10 of the cryostat comprises a series of metal shields 13. Each of these shields hinders thermal radiations and thus allows keeping the central enclosure 14 at regulated temperatures. Thus, all of the shields achieves a function of thermal insulation of the space component operating at cryogenic temperature with respect to the spatial outside environment and with respect to the satellite platform.

In the described example, each integral portion 10a, 10b comprises a plurality of successive partitions 13a, 13b, coaxial and spaced apart from one another which, when the integral portions are assembled, integrally form the successive shields.

For example, the partitions 13a, 13b of each integral portion 10a, 10b may have identical shapes but with increasing sizes from the internal partition 13a(1), 13b(1) up to the external partition 13a(3), 13b(3), passing through successive intermediate partitions 13a(2) and 13b(2). Thus, in the two integral portions, the partitions include cylindrical sections open at one end and closed at the other end by substantially conical sections.

Each of the two integral portion is a structural portion wherein each internal, intermediate and external partition includes an annular portion. The annular portion of each partition extends, in one-piece, by a conical closed portion.

Each of the circular openings of the partitions lies opposite a circular opening of another partition to form a shield. Thus, each shield is composed of a conical portion extended by a portion with a circular section itself lying in line with another circular portion extending through a conical portion.

The two integral portions comprise an identical number of partitions (eight in the illustrated example, i.e. six intermediate partitions), which therefore associate in pairs, the number of partitions possibly varying according to the desired insulation performances.

The paired intermediate partitions 13a(2) and 13b(2) have their portion with a circular section facing and in line with one another.

Moreover, the two integral portions 10a and 10b are fastened together by the fastening flanges 111a, 111b at their external partition.

For example, the ends facing one another and at a distance from the intermediate partitions also form a recess. For each pair of associated partitions 13a(2), 13b(2), the end of one of the partitions, for example, the end 130a of the partition 13a(2) has a U-shaped section over its entire periphery, which defines a “female” portion, inside which the end 130b of the other partition 13b(2), which has a straight section over its entire periphery, advances as a “male” portion. These two ends remain at a distance from one another. The same applies to the internal partitions 13a(1) and 13b(1).

For example, the distribution of the male and female portions may be alternated between the partitions 13a, 13b of either one of the integral portions.

Thus, the approach area between two partitions 13a and 13b draws a baffle 130c which contributes to limiting the radiative heat exchanges between two successive shields 13.

Preferably, this approach area is done without contact, in order to limit frictions between partitions under the effect of the vibrations to which the cryostat is subjected. Thus, the successive metal shields form successive non-sealed obstructions.

For example, the junctions (i.e. the approach areas) follow a frustoconical arrangement, materialized in dashed lines in FIG. 2.

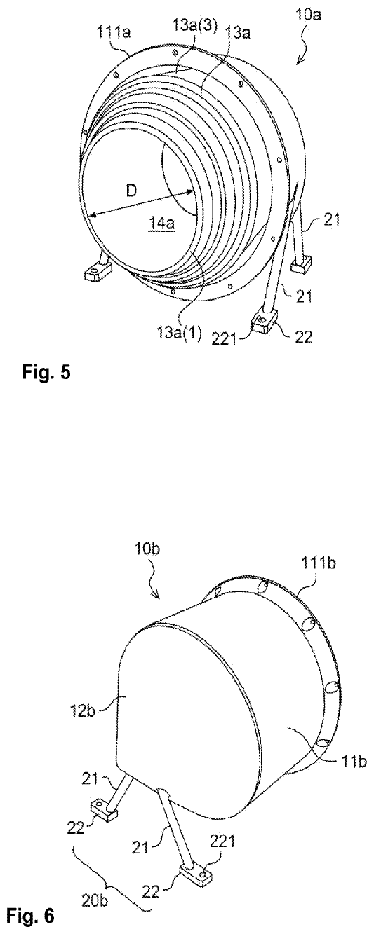

Thus, as illustrated in FIG. 5, the partitions 13a of the integral portion 10a project, for example, with respect to the plane containing the assembly face of the flange 111a, with a projection length increasing from the external partition 13a(3) to the internal partition 13a(1). In turn, the partitions 13b of the integral portion 10b, visible in FIG. 7, are set back with respect to the plane containing the assembly face of the flange 111b, with a setback length increasing from the external partition 13b(3) to the internal partition 13b(1), so that the integral portion 10b has a shape complementary to that of the integral portion 10a to enable connection according to the configuration illustrated in FIG. 2.

The internal partitions 13a(1) and 13b(1) of the integral structural portions 10a and 10b have an identical diameter D which delimits useful volumes 14a and 14b respectively, the association of which forms the central enclosure 14 receiving the space component to be cooled.

Recall that the thermal insulation ensured by the cryostat 100 requires the shields 13 to be spaced apart from one another and held in this position. Furthermore, the joining elements coming into contact with two successive shields are optimized so as to limit heat exchanges by conduction.

To this end, the partitions 13a, 13b of each integral portion 10a, 10b are connected together by internal joining elements 30, the arrangement of which allows optimizing both the stiffness, the mechanical strength and the thermal conduction of the mechanical-thermal structure of the cryostat. Thus, the cryostat as a whole has good thermal resistance between the central enclosure 14 and the outside environment. The cryostat also has good stiffness and mechanical strength while taking account of the conditions of use of the cryostat, which could be extreme in terms of experienced accelerations and vibrations (in particular during the launch phase of the spacecraft in which the cryostat is installed).

Thus, the cryostat as a whole has good thermal resistance between the central enclosure 14 and the outside environment.

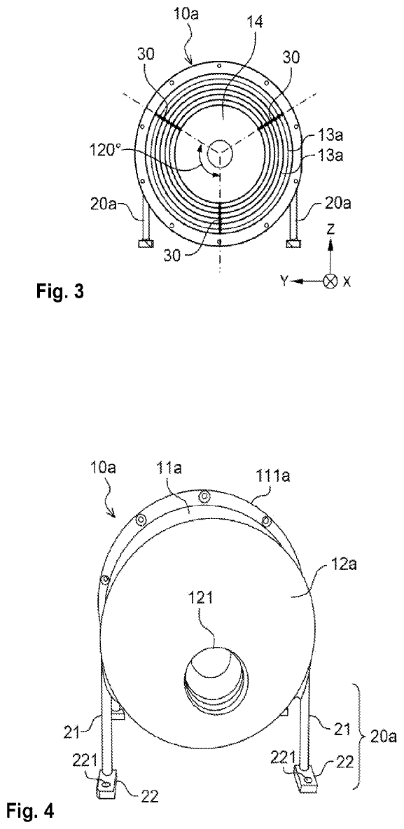

For example, in each integral portion, the internal joining elements 30 may be distributed radially into several groups evenly distributed over 360°. For example, the internal joining elements 30 are distributed into three groups in three straight lines forming, in pais, an angle of 120° as shown in FIG. 3.

Moreover, external securing elements 20 hold the external shield, and therefore the body 10 of the cryostat, to a satellite platform (not shown). These external securing elements are optimized both in mechanical terms so as to guarantee good holding of the cryostat, and in thermal terms, so as to limit heat exchanges between the body 10 of the cryostat and its outside environment (in particular said satellite platform).

For example, the external securing elements 20 are in the form of bipods and each includes two V-shaped branches 21 each terminating in a sole 22 enabling fastening of the cryostat to the satellite platform, for example by suitable bores 221 which will receive specific fastening elements such as screws, washers and nuts.

In the illustrated example, the cryostat 100 includes three outer bipods 20 including two bipods 20a secured to one of the integral portions 10a, and one bipod 20b secured to the other integral portion 10b. Thanks to different orientations of the bipods, all of the degrees of freedom of the external shield 13(3) relative to the satellite platform are eliminated.

For example, the integral portion fastened to two bipods is intended to support the space component operating at cryogenic temperature.

As shown in FIG. 4, the space component operating at cryogenic temperature, such as an optical detector, operates through a front window 121, formed at the top of a conical portion and closed by one or more glass(es).

The external bipods 20 connect the cryostat 100 to a satellite platform, by being physically in contact with the latter, and therefore form a conduction medium in which the thermal diffusion between the platform and the cryostat is established.

The internal joining elements 30, connecting the shields 13 together, also achieve mechanical holding, while limiting heat transfers by conduction, thanks to specific arrangements.

The integral portions comprising several partitions, each forming a shield portion, may be obtained by additive manufacturing (3D printing).

For example, the internal inter-shield joining elements are made in one-piece with partitions, in particular if additive manufacturing is used.

For example, the construction material is invar or titanium.

For example, the geometric arrangement of the internal joining elements 30 between the shields 13 will be optimized and validated by series of mechanical and thermal simulations and tests carried out using computer tools and experimental setups.

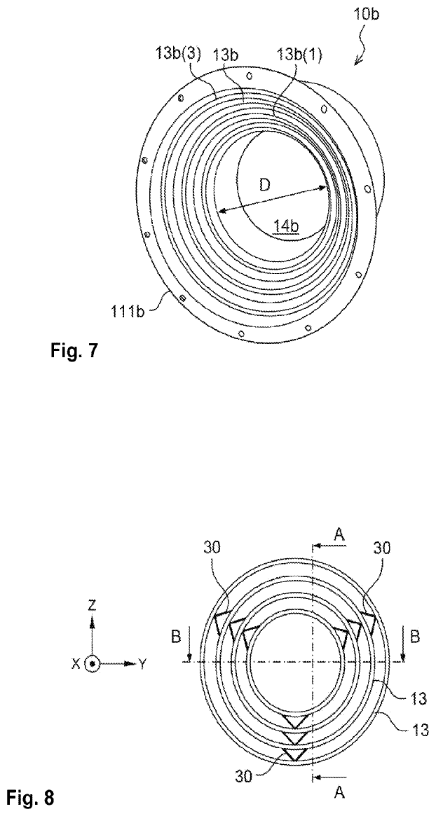

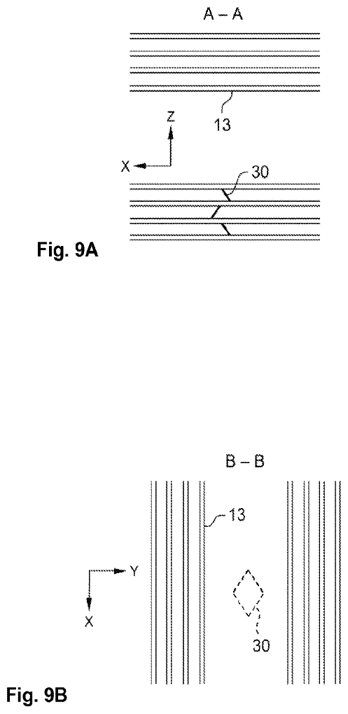

FIGS. 8, 9A and 9B schematically show a geometric arrangement of the internal joining elements 30 according to an embodiment of the invention. For better readability, the shields 13 are illustrated in a reduced number in these figures. This geometric arrangement has been selected on the basis of mechanical and thermal simulations; it allows obtaining the expected results in terms of mechanical strength and thermal resistance.

As shown in FIG. 8, the internal joining elements 30 are distributed in three radial directions, i.e. into three groups evenly distributed over 360° in a transverse plane, the axes of said groups defining, in pairs, an angle herein equal to 120°. For each integral portion, each group of internal joining elements comprises, for example, an internal joining element 30 between each pair of consecutive shields.

The internal inter-shield joining elements are optimized in terms of cross-section to guarantee the mechanical strength of the cryostat and at the same time to limit the thermal conduction (the smaller the section of the internal joining element 30, the lower the thermal conduction will be).

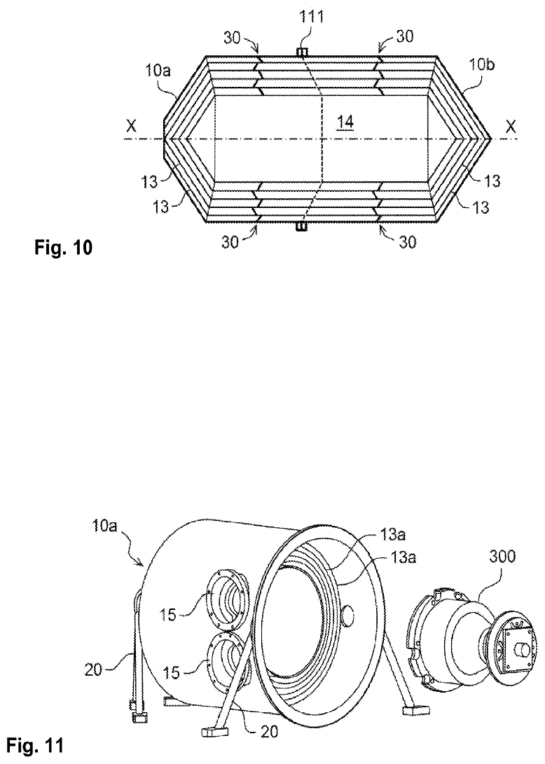

In the embodiment of FIGS. 8 to 10, each internal joining element 30 is formed by a V-shaped double rod, including two branches defining a plane. As explained hereinafter, this plane may be inclined with respect to a transverse plane of the cryostat body.

Referring to FIGS. 9A and 9B, showing their longitudinal position, the internal joining elements 30 are for example inclined with respect to a transverse plane (in this case, herein, the bases of the V are all located in the same first transverse plane whereas the free ends of the branches of the V are located in transverse planes adjacent to this first transverse plane), this inclination being done alternately in the direction of either one of the axial ends of the body 10.

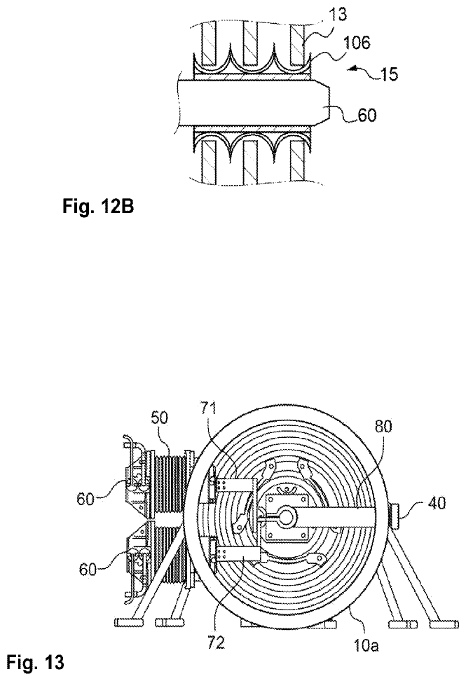

As shown in FIG. 12, two cold fingers 60 pass through the shields to cool the central enclosure 14. Each cold finger is arranged at a distance from the shields.

As shown in FIG. 12A, a heat-insulating coating 105, for example of the multilayer type, also so-called “MLI” (acronym for multi-layer insulation in English), may be arranged, in the transverse passage 15, against each cold finger 60, thereby reinforcing the thermal insulation of the cryostat.

Alternatively or possibly in combination, as shown in FIG. 12B, a bellow-fashioned heat-insulating cowl 106, for example made of polymer, may be arranged, around each cold finger 60, in the transverse passage 15 and between the shields 13.

FIGS. 15 to 18 show an embodiment wherein the cryostat 100 consists of three integral portions: a base 110a, an annular central portion 110b and a cowl 110c, which are assembled together so as to form the body of the cryostat. Each of the integral portions includes a plurality of insulation partitions 113a, 113b and 113c, and have shapes adapted to the integration of a given space component 300. The shapes of the different integral portions 110a, 110b and 110c are also complementary so that each partition of an integral portion is associated with one of the partitions of each of the other two integral portions to form a shield.

More particularly, according to this embodiment, the body of the cryostat 100 has a generally parallelepipedal shape, whose central integral portion 110b materializes the lateral faces, and whose base 110a and cowl 110c respectively materializing the lower face and the upper face.

The central integral portion 110b comprises a series of annular partitions 113b arranged at a distance from one another coaxially around a main axis X (materialized in FIG. 15). In particular, it comprises an internal partition 113b(1) delimiting the enclosure 114 which receives the space component 300 operating at cryogenic temperature, intermediate partitions 113b(2), and an external partition 113b(3).

In this example, the intermediate partitions and the internal partition have similar shapes and increasing dimensions from the inside to the outside. On the other hand, the external partition 113b(3) deviates at some locations from the outermost intermediate partition to form compartments for receiving various functional members of the cryostat such as electrical connection means.

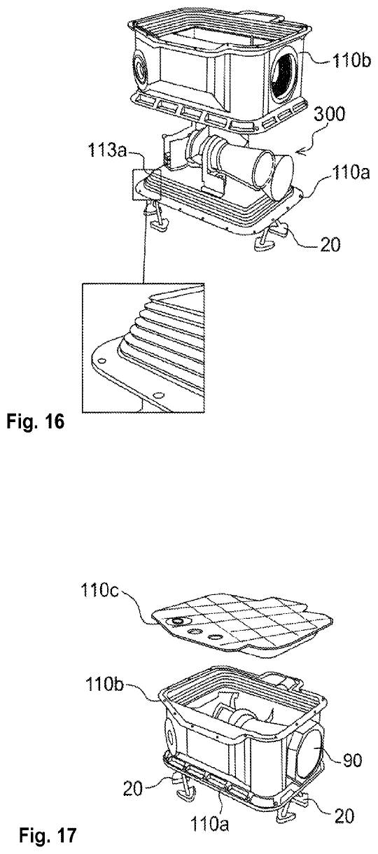

The base 110a and the cowl 110c comprise planar partitions 113a and 113c arranged at a distance from one another and having decreasing dimensions from the outside of the cryostat towards the inside, conferring a pyramidal appearance on the base and on the cowl. This pyramidal shape, clearly visible in the detail of FIG. 16, allows for a good accommodation of the cryostat.

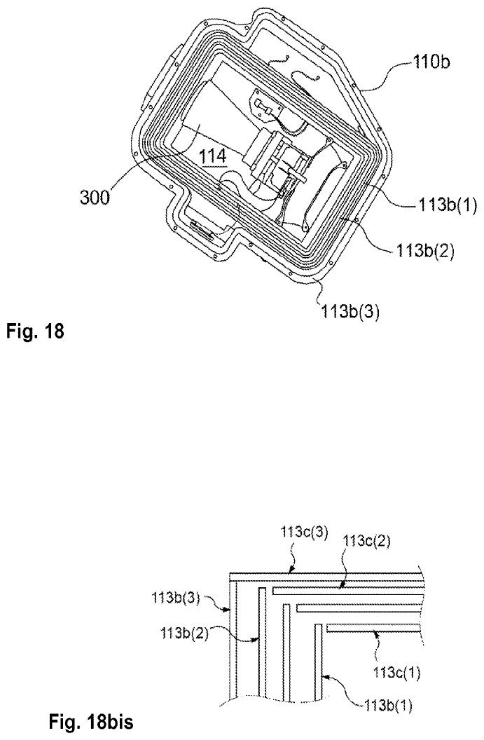

As shown in FIG. 18b is, the internal 113b(1), 113c(1) and intermediate 113b(2), 113c(2) partitions of the two integral portions are arranged in the vicinity of one another to form a closed shield in a non-sealed manner, while having their ends at a distance from one another. These two integral portions may correspond to the central integral portion 110b and to the cowl 110c or to the central integral portion 110b and to the base 110a.

In this embodiment of the cryostat 100 made into three integral portions, only the base 110a is provided with external bipods 20 (forming external securing elements between the cryostat and a satellite platform), which allows concentrating the force paths only in said base.

Like the embodiment described above, the outer bipods 20 and the internal joining elements can be manufactured from the same material as the partitions 113a, 113b or 113c to which they are associated, for example made of a metal material having adequate thermal and mechanical properties, preferably made of titanium.

Titanium offers a good tradeoff between mechanical properties (sufficient stiffness and strength) and thermal properties (relatively low thermal conductivity in comparison with other metals like aluminum, for example). What is more, titanium is compatible with 3D printing.

The use of an additive manufacturing technique, such as the laser fusion technology on a powder bed, is advantageous in that it enables the manufacture of several elements (partitions, internal joining elements, and external securing elements) into one monolithic part. What is more, additive manufacturing allows obtaining metal parts of fine, complex and entangled shapes as is the case with the integral portions (presence of a plurality of internal partitions connected by joining elements) with a specific configuration.

Other manufacturing techniques may be used, as well as materials other than titanium, including materials that are not compatible with 3D printing, the latter being just an optional, still advantageous, method for manufacturing the cryostat according to the invention. Even though additive manufacturing is not used, the design of the cryostat according to the invention remains relatively simple. In any case, the cryostat according to the invention has at least the advantage of compactness and that of being able to accommodate one or more space component(s) operating at cryogenic temperature of various shapes and sizes.

Depending on the overall geometry of the cryostat, which is primarily imposed by the shape of the space component that it is intended to accommodate, and depending on the number of integral portions that compose the cryostat, as well as the selected material(s), thermal and mechanical computer simulations are executed to determine the number of shields 13, as well as their thicknesses and the thickness of the vacuum blades separating them, allowing achieving, without specific coatings or SLI (acronym for “Single Layer Insulation” in English) sheets or multilayer MLI (Multi Layer Insulation) insulation, thermal and mechanical performances equivalent to or higher than those of cryostats of the prior art.

Typically, this number has been evaluated at seven shields under some usual operating conditions.

More generally, the number of shields may be adapted depending on the missions, to comply with specific thermal specifications. For example, it might happen that the target temperatures in the internal volume of the cryostat are higher than the aforementioned values (60 K and 100 K), in which case a lower number of intermediate shields, for example two or three, would be enough to ensure the targeted thermal insulation.

Another advantage of the invention is that, if it is desired to increase the thermal insulation performances of a cryostat, it is possible to choose to add one or more shield(s) to an already proven initial design, without this having a significant impact on the process of design, qualification and manufacture of the cryostat. This is all the more true when 3D printing is used. Indeed, it proves to be less expensive and less constraining to add to the cryostat an additional intermediate shield, which will be manufactured by 3D printing at the same time as the initial shields, rather than insert single-layer SLI or multilayer MLI insulation sheets between two successive shields of an initial cryostat for example.

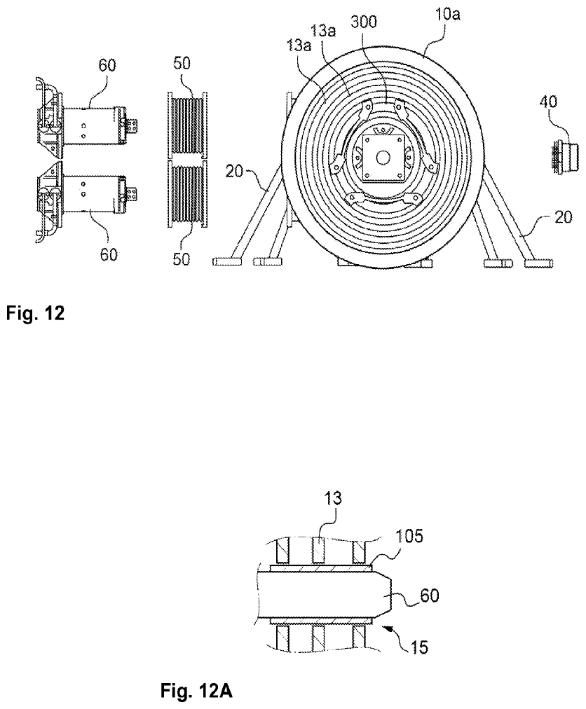

The installation of a space component, such as a sensor, in the cryostat is illustrated in FIGS. 11 to 14.

In a first step, the space component 300 is positioned inside the first integral portion 10 a and fastened to the internal partition 13a(1) using suitable connection means. Afterwards, electrical connectors 40 and cold fingers 60 are installed on the body of the cryostat.

For example, at least one transverse channel is formed in the successive shields up to the central enclosure for the passage of electric power supply means and/or means of communication with the space component, which channel is closed at the external shield by a heat-insulated connection interface.

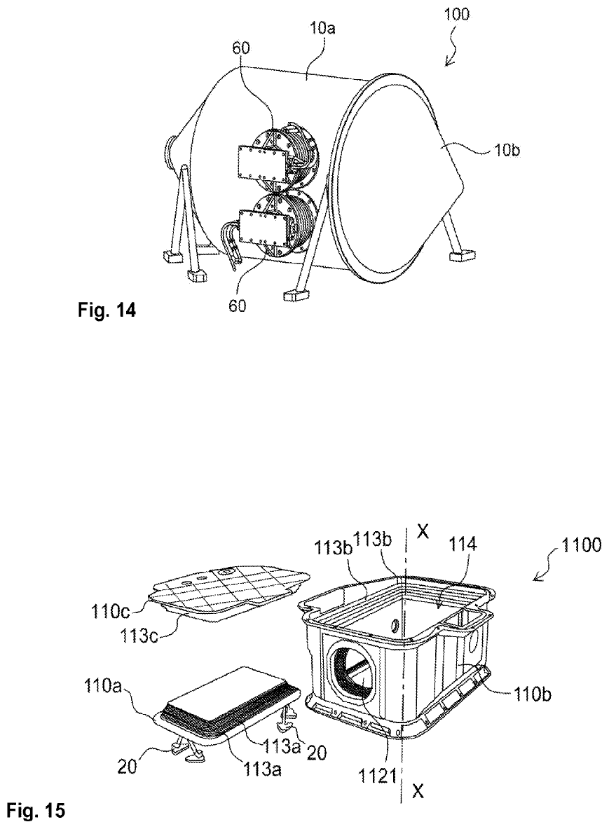

Preferably, bellows 50 are provided around the cold fingers 60 to limit the effects of the micro-vibrations generated by the compressor on the fingers and to thermally insulate them. The cold fingers are inserted into passages 15 formed in the body, the passages 15 passing through all of the partitions 13a up to the central enclosure 14. Other functional members are installed before closure of the cryostat is closed, including:
a specific electrical wiring 80 between the electrical connection interface 40 and the space component 300 operating at cryogenic temperature, which wiring is accommodated in a channel formed in the different partitions 13a, this channel passing through said partitions up to the central enclosure 14.
multi-sheet thermal braids 71 and 72 made of aluminum (cf. FIG. 13) between the cold fingers 60 and the space component operating at cryogenic temperature, which braids are also inserted into the passages 15 in the extension of the cold fingers,
a transparent heat shield 90 (not shown in FIGS. 11 to 14 but a similar shield is shown in FIG. 17) which is placed frontally in front of the focal plane of the space component 300. Afterwards, the second integral portion 10b is assembled to the first one in order to close the cryostat, thereby isolating the space component, such as an optical sensor, as shown in FIG. 14.

Afterwards, the cryostat may be mounted on a satellite platform thanks to its external securing elements (bipods) 20.

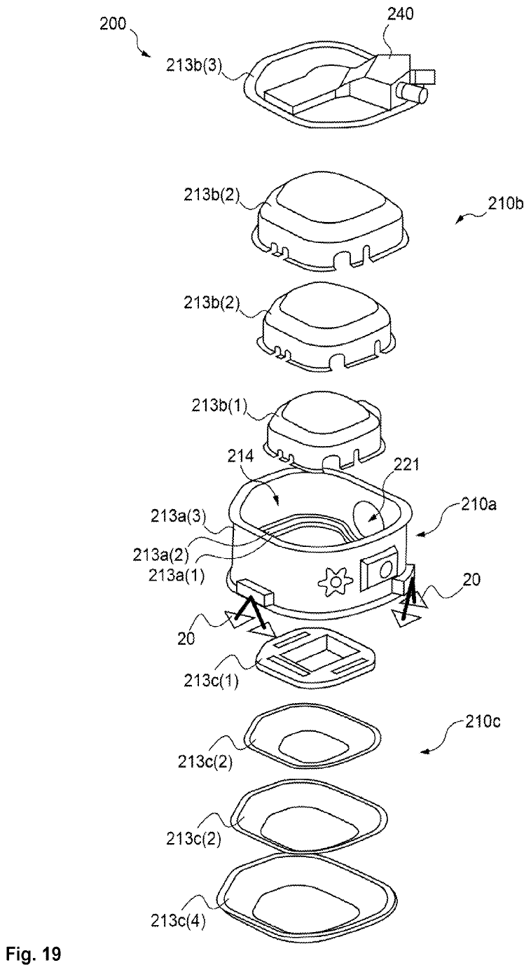

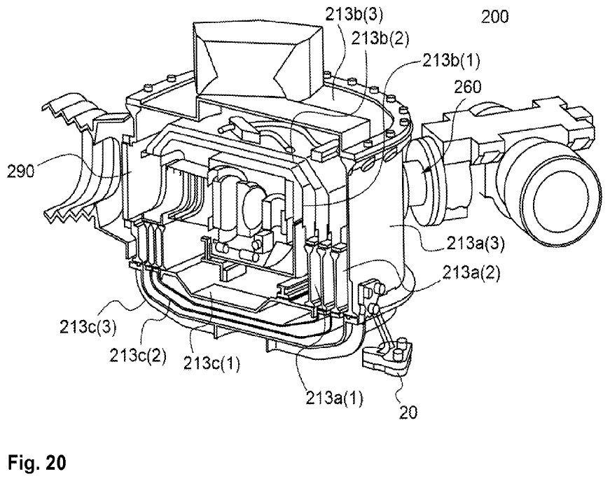

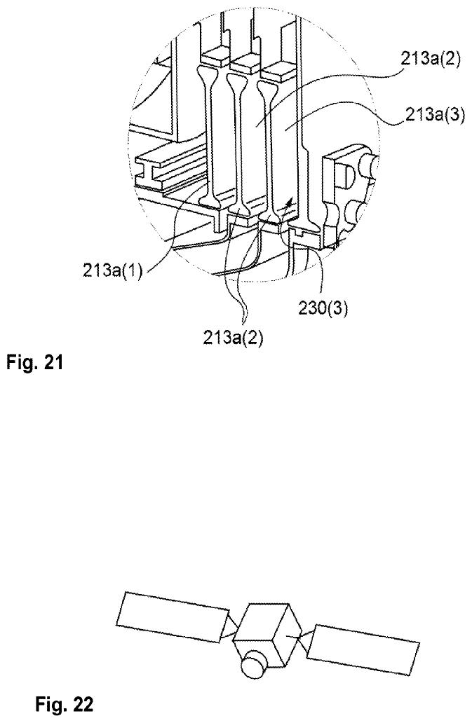

FIGS. 19 to 21 illustrate a third embodiment according to the invention.

This cryostat 200 comprises one single integral portion 210a, a first series 210b of independent upper cowls 213b and a second series 210c of independent lower cowls 213c.

For example, the integral portion 210 a is made by 3D printing. For example, the cowls are made by 3D printing or by machining, and then treated in order to add a golden plating thereto.

The integral portion 210a is similar to the central integral portion 110b of the embodiment of FIGS. 15 to 18 in that it is generally annular and cylindrical with an axis X, and in that it comprises a plurality of partitions, including an internal partition 213a(1), which partially delimits a central enclosure 214 intended to receive the space component to be maintained at very low temperatures, an external partition 213a(3) and several-in the example two-intermediate partitions 213a(2). All of the partitions are generally cylindrical, coaxial, spaced apart from one another; they have increasing dimensions from the internal partition 213a(1) to the external partition 213a(3).

The partitions of the integral portion 210a are secured to one another by internal joining elements which may be V-shaped double rods as previously described for the embodiment of FIGS. 8 to 10.

FIG. 21 shows an alternative embodiment for the internal joining elements. In this alternative, the internal joining elements comprise several sets, including a set 230 and a set 231, of straight simple rods. The rods 230(1), 230(2) and 230(3) of the same set 230 (the same applies for the set 231) are aligned and extend in a longitudinal plane containing the main axis X of the integral structural portion 210a, according to a direction inclined with respect to a transverse plane. In other words, the rods of the same set extend in the same direction, which intersects the main axis X but forms with this axis an angle which is not equal to 90°.

In addition, the directions according to which the simple rods are aligned form with a transverse plane (or with the axis X) angles which, preferably, vary from one set to another, so that the connection points between the external partition 213a(3) and the rod 230(3) associated with said partition are located at heights (along the axis X) which vary from one set of rods to another.

Alternatively, the straight lines according to which the two sets of rods 230 and 231 are arranged have the same angle of inclination with respect to the central axis X of the integral portion.

As explained before for the V-like internal joining elements, the alignment of the rods per set, with judiciously selected angles and/or directions, offer a good tradeoff between mechanical strength and thermal resistance.

Besides the central integral portion 210a, the cryostat comprises a first series of upper cowls 210 b comprising an internal upper cowl 213b(1), one or more-in the example two-intermediate upper cowls 213b(2), and an external upper cowl 213b(3). Similarly, the cryostat comprises a second series of lower cowls 210c, comprising an internal lower cowl 213c(1), two intermediate lower cowls 213c(2) and an external lower cowl 213c(3).

The internal, respectively upper 213b(1) and lower 213c(1), cowls lie axially in line with the internal partition 213a(1) of the integral portion 210a and are fastened to the latter. Thus, the internal partition 213a(1) and the two internal cowls 213b(1) and 213c(1) form an internal shield which delimits a closed enclosure 214 intended to accommodate the space component 300 to be cooled.

The smallest amongst the lower intermediate cowls 213c(2) and the smallest amongst the upper intermediate cowls 213b(2) are axially in line with the smallest amongst the intermediate partitions 213a(2) of the integral portion 210a and are fastened to said partition to form a first intermediate shield surrounding the internal shield. Similarly, the largest amongst the lower intermediate cowls 213c(2) and the largest amongst the upper intermediate cowls 213b(2) is axially in line with the largest amongst the intermediate partitions 213a(2) of the integral portion 210a and are fastened to said partition to form a second intermediate shield surrounding the first intermediate shield.

Finally, the external, respectively upper 213b(3) and lower 213c(3) cowls, are axially in line with the external partition 213a(3) of the integral portion 210a and are fastened to this partition to form an external shield.

In other words, unlike the aforementioned partitions, the cowls are not connected to one another and therefore do not form structural integral portions capable of supporting and transmitting forces from one shield to another.

Preferably, the upper 213b(1) to 213b(3) and lower cowls 213c(1) to 213c(3) cowls are entirely covered with a golden coating. This golden coating allows modulating the emissivity and absorptivity properties governing the radiative transfer and thus optimizing the radiative environment. For example, this gold plating of the cowl is obtained by electrolytic deposition over a part obtained by machining or 3D printing.

In addition, the cryostat 200 comprises external securing elements 20 in the form of bipods for securing it to a satellite platform. All of the external bipods 20 of the cryostat 200 are fastened to the integral portion 210a so that all of the forces to which the space component operating at cryogenic temperature is subjected pass through this integral portion, whose rigidity is guaranteed by the internal inter-shield joining elements.

On the other hand, the connection interface 240 for electric power supply and control of the instrument, as well as the recovery of the measurement data captured by the instrument, may be carried by an external cowl, for example the upper external cowl 213b(3).

Of course, the cryostat also comprises a device for cooling the enclosure 214, for example at least one insulated cold finger 260 which passes through the shields and may be extended by a thermal braid to reach and cool the central enclosure 214.

The cold finger may be isolated from the shields by a multilayer insulating (MLI) sleeve, such as the sleeve 105 illustrated in FIG. 12A, the passage formed in the shields to receive the insulated cold finger being preferably large enough for the MLI sleeve not to be in contact with the partitions 213a. Alternatively or in combination, the cold finger may be isolated from the shields by a bellow-fashioned polymer film, such as the film 106 of FIG. 12B, coming into contact with the partitions 213a.

In addition, the cryostat 200 comprises a transparent heat shield 290 which fills and thermally insulates an opening 221 (cf. FIG. 19) formed in the body of the cryostat opposite the space component operating at cryogenic temperature, such as an optical detector.

The cryostat according to the invention is not limited to the illustrated examples. Thus, for example, the cryostat could comprise two integral portions and one single series of independent cowls, for example a central integral portion, similar to the annular central portion 210a of FIG. 19, a lower integral portion forming a base such as the base 10a of FIGS. 15 to 18, and a series of upper independent cowls such as the cowls 213b(1) to 213b(3) of FIG. 19. In this case, the external securing elements may be either all fastened to the central integral portion, or all fastened to the lower integral portion (base), or distributed over the two integral portions.

Alternatively, the cryostat could comprise one single integral portion and one single series of independent cowls, namely for example:
an integral portion, comprising a cylindrical section corresponding to an annular central portion of the body and a conical or planar section corresponding to a lower portion (or base) of the body,
and a series of upper cowls.

Of course, other combinations are possible.

In the various combinations proposed before, the term “integral” in the expression “integral portion” implies that this portion is in the form of a one-piece block like, for example, a monolithic block obtained for example by 3D printing.

For example, an integral portion is self-supporting and rigid to enough to take up, during operation, all of the forces experienced by the cryostat and the component that it contains. Because it perfectly meets the very low temperatures requirements and because it has an improved mechanical behavior, the mechanical-thermal structure of the cryostat 100 or 200 according to the invention is particularly suited to missions carrying ultrasensitive instrumentation, in particular for infrared detection, which should operate at extremely low temperatures to plot accurate maps of temperature fluctuations, sometimes in the range of one hundred thousandth degree. Such an instrumentation may comprise optical surfaces (lenses, mirrors, etc.), infrared sensors, bolometers, etc. Of course, this does not limit the applications of the cryostat of the invention, which could cooperate with other types of instruments or components operating at less extreme temperatures. The use of an additive manufacturing technology enables the manufacture of this judicious design while allowing for competitive manufacturing cost and time.

1. A cryostat for at least one space component operating at cryogenic temperature, the cryostat comprising:
a central, closed and cooled enclosure, configured to receive the space component,
successive metal shields, spaced apart from one another, including an internal shield, an external shield and one or more intermediate shield(s), the internal shield supporting the space component and delimiting the central enclosure receiving said space component, the intermediate shield(s) and the external shield being arranged around one another so that each delimits a closed volume receiving the preceding shield of smaller size,
a cooling device for cooling the central enclosure at cryogenic temperature,
external securing elements fastened to the external shield, for securing the cryostat to a satellite platform,
internal inter-shield joining elements, which hold said shields spaced apart from one another,
the cryostat being characterized in that it comprises at least one integral portion comprising a series of partitions including an internal partition, an external partition and one or more intermediate partition(s), respectively corresponding to a portion of the internal shield, a portion of the external shield and a portion of the one or more intermediate shield(s), said partitions being spaced apart from one another and held together by at least one portion of the internal inter-shield joining elements.

2. The cryostat according to claim 1, wherein the cooling device comprises one or more cold finger(s) for cooling the central enclosure and, for each of the cold fingers, a transverse passage passing through the successive metal shields up to the central enclosure-for receiving said cold finger, the cold finger(s) not being in contact with the shields.

3. The cryostat according to claim 1, wherein the internal inter-shield joining elements are arranged between the successive shields and configured to confer mechanical strength thereon on their own between the external shield and the internal shield, said internal joining elements being configured to withstand determined forces induced at least by a mass of the space component and masses of the shields.

4. The cryostat according to claim 1, wherein the internal inter-shield joining elements comprise V-shaped double rods between the successive shields, the Vs being angularly distributed around a main axis (X) or a central point of the cryostat according to at least three radial directions.

5. The cryostat according to claim 1, wherein the internal inter-shield joining elements comprise several sets of single rods, the single rods of a same set being aligned according to a straight line passing through the shields, the straight lines of two distinct sets being non-parallel and non-coplanar with one another.

6. The cryostat according to claim 1, wherein the internal inter-shield joining elements are made in one-piece with at least an integral portion of the shields.

7. The cryostat according to claim 1, wherein said integral portion is made by additive manufacturing.

8. The cryostat according to claim 1, wherein:
the cryostat comprises a plurality of integral portions each having an internal partition, an external partition and one or more intermediate partition(s), the partitions of two distinct integral portions among said integral portions corresponding to two distinct portions of the shields,
the intermediate or internal partitions of two distinct and adjacent integral portions among the plurality of integral portions, which are in line with one another being non-contiguous,
the external partitions, of two distinct and adjacent integral portions among the plurality of integral portions, which are in line with one another being contiguous and fastened to one another.

9. The cryostat according to claim 8, wherein the intermediate or internal partitions which are in line with one another, have facing ends at least one of these facing ends has a recess so as to form a baffle with the other facing end.

10. The cryostat according to claim 1, wherein the external securing elements are either all fastened on the external partition of only one of the integral portions, or distributed over the external partitions of several ones of the integral portions.

11. The cryostat according to claim 1, wherein at least one of said integral portions is an annular structural portion wherein each internal, intermediate and external partition is annular.

12. The cryostat according to claim 1, wherein each of the shields of the cryostat is entirely formed by the assembly of the partitions of the integral portions.

13. The cryostat according to claim 11, wherein:
the cryostat comprises at least one series of independent cowls including, for each series, an internal cowl, an external cowl and one or more intermediate cowl(s), each series of cowls respectively corresponding to another portion of the shields, the cowls of the same series being arranged inside one another, at a distance from one another, with no internal joining elements,
each of said cowls lying in line with and being fastened to one of the partitions of said annular structural portion, each of the shields of the cryostat thereby being entirely formed by at least one of the partitions of the annular structural portion and by one of the cowls of each series.

14. The cryostat according to claim 13, wherein at least one portion of each of the cowls is provided with a golden coating.

15. The cryostat according to claim 2, wherein each of the cold fingers is thermally insulated from the shields, a heat-insulating coating being arranged against at least one of the cold fingers in the transverse passage of said cold finger, and/or a bellow-fashioned heat-insulating coating being arranged around at least one of the cold fingers, in the transverse passage of said cold finger and between the shields.

16. A spacecraft comprising a space component configured to operate at cryogenic temperature and is configured in the cryostat according to claim 1, wherein the cryostat is fastened on a platform of the spacecraft.
